(19) United States
(12) Patent Application Publication
(10) Pub. No.: US 2026/0010660 A1
(43) Pub. Date: Jan. 8, 2026

(54) SYSTEM, METHOD, AND NON-TRANSITORY COMPUTER-READABLE STORAGE MEDIUM

(71) Applicant: Nintendo Co., Ltd., Kyoto-shi (JP)

(72) Inventors: Toshiaki OOMORI, Kyoto-shi (JP); Koichiro YOSHIOKA, Kyoto-shi (JP); Akifumi FUJITA, Kyoto-shi (JP)

(21) Appl. No.: 19/220,831

(22) Filed: May 28, 2025

(30) Foreign Application Priority Data
Jul. 5, 2024 (JP) 2024-108750

(51) Int. Cl. G06F 21/84; G06F 3/0482

(52) U.S. Cl. CPC G06F 21/84; G06F 3/0482

(57) ABSTRACT

An information processing system includes one or more servers, a distribution terminal configured to distribute an image, and a plurality of reception terminals configured to receive the image. The distribution terminal is configured to obtain display policy information and to transmit the display policy information and the image. The one or more servers are configured to transmit the display policy information while filtering distribution of the image. Each of the plurality of reception terminals is configured to determine whether or not it is permitted to show the image based on the display policy information. The one or more servers are configured to stop the filtering when a result of determination indicates permission to show the image.

This nonprovisional application claims priority on Japanese Patent Application No. 2024-108750 filed on Jul. 5, 2024 with the Japan Patent Office, the entire contents of which are hereby incorporated by reference.

### FIELD

The present disclosure relates to a system, a method, and a non-transitory computer-readable storage medium.

### BACKGROUND AND SUMMARY

A system has been known, which is configured to obtain age of a user who operates an information processing terminal and to determine whether or not the obtained age is equal to or higher than a qualifying age set in advance for each application to be executed in the information processing terminal.

With development of communication technology, a system configured to allow a plurality of information processing terminals to exchange various types of data among them has recently been available. For example, a distribution system configured to distribute in real time, an image of an application running in a certain information processing terminal to another information processing terminal has been available. In such a distribution system, an image of an application running in one distribution terminal may be distributed to a plurality of reception terminals.

For an application, a condition indicating whether or not an information processing terminal is permitted to execute the application may be set. In the distribution system described above, whether not only a distribution terminal which is an entity to execute the application but also a plurality of reception terminals to which an image of the application is to be distributed are permitted to show the image should be determined.

(Configuration 1) A system according to one embodiment includes one or more servers, a distribution terminal configured to distribute an image of a running application via the one or more servers, and a plurality of reception terminals configured to receive the image distributed by the distribution terminal. The distribution terminal includes one or more memories storing instructions that, when executed, cause one or more computers of the distribution terminal to perform operations including obtaining display policy information of the running application and transmitting the display policy information and the image to at least one of the one or more servers. At least one of the one or more servers includes one or more memories storing instructions that, when executed, cause one or more computers of the at least one of the one or more servers to perform operations including transmitting the display policy information to each of the plurality of reception terminals while filtering distribution of the image. Each of the plurality of reception terminals includes one or more memories storing instructions that, when executed, cause one or more computers of the each of the plurality of reception terminals to perform operations including determining whether the each of the plurality of reception terminals itself is permitted to show the image based on the display policy information obtained from the at least one of the one or more servers and transmitting a result of determination to the at least one of the one or more servers. The operations performed by the at least one of the one or more servers include stopping the filtering for the each of the reception terminals indicated by the result of determination as being permitted to show the image, among the plurality of reception terminals.

(Configuration 2) In Configuration 1, the display policy information includes information on age restriction. The operations performed by the distribution terminal include obtaining from the application, the information on the age restriction included in the application.

(Configuration 3) In Configuration 2, the operations performed by the each of the plurality of reception terminals include determining whether the each of the plurality of reception terminals is permitted to show the image based on age information youngest of age information associated with one or more accounts associated with the each of the reception terminals and the display policy information obtained from the at least one of the one or more servers.

(Configuration 4) In any of Configurations 1 to 3, the display policy information includes information on a country. The operations performed by the distribution terminal include obtaining the information on the country corresponding to the running application from the at least one of the one or more servers.

(Configuration 5) In any of Configurations 1 to 4, the operations performed by the distribution terminal include transmitting application identification information for identification of the running application to the at least one of the one or more servers. The operations performed by the at least one of the one or more servers include transmitting the application identification information together with the display policy information to the each of the plurality of reception terminals. The operations performed by the each of the plurality of reception terminals include transmitting the application identification information together with the result of determination based on the display policy information to the at least one of the one or more servers. The operations performed by the at least one of the one or more servers include stopping the filtering for the each of the reception terminals indicated by the result of determination as being permitted to show the image, of which application identification information matches with the application identification information received from the distribution terminal.

(Configuration 6) In any of Configurations 1 to 5, the operations performed by the distribution terminal include transmitting, when the distribution terminal starts distribution of the image, an image to the at least one of the one or more servers.

(Configuration 7) In any of Configurations 1 to 6, the operations performed by the distribution terminal include transmitting, when the distribution terminal starts distribution of a home menu image, home menu image information indicating that an image to be transmitted is the home menu image to the at least one of the one or more servers. The operations performed by the at least one of the one or more servers include skipping the filtering distribution of the home menu image based on the home menu image information.

(Configuration 8) In Configuration 6, the operations performed by the at least one of the one or more servers include filtering, when the distribution terminal changes from distribution of the image of the running application to distribution of a home menu image and thereafter changes to distribution of the image of the application identical to the image before distribution of the home menu image, distribution of the image of the application for the each of the plurality of reception terminals based on filtering information indicating for which reception terminal the image of the application distributed by the distribution terminal before distribution of the home menu image is filtered.

(Configuration 9) A method according to one embodiment is a method of distributing, by a distribution terminal, an image of a running application via one or more servers with an information processing system. The method includes, at the distribution terminal, obtaining display policy information of the running application and transmitting the display policy information and the image to at least one of the one or more servers, at the at least one of the one or more servers, transmitting the display policy information to each of a plurality of reception terminals while filtering distribution of the image, at the each of the plurality of reception terminals, determining whether the each of the plurality of reception terminal itself is permitted to show the image based on the display policy information obtained from the at least one of the one or more servers and transmitting a result of determination to the at least one of the one or more servers, and at the at least one of the one or more servers, stopping the filtering for the each of the plurality of reception terminals indicated by the result of determination as being permitted to show the image, among the plurality of reception terminals.

(Configuration 10) In Configuration 9, the display policy information includes information on age restriction. The method further includes, at the distribution terminal, obtaining from the application, the information on the age restriction included in the application.

(Configuration 11) In Configuration 10, the method further includes, at the each of the plurality of reception terminals, determining whether the each of the plurality of reception terminals is permitted to show the image based on age information youngest of age information associated with one or more accounts associated with the each of the reception terminals and the display policy information obtained from the at least one of the one or more servers.

(Configuration 12) In any of Configurations 9 to 11, the display policy information includes information on a country. The method further includes, at the distribution terminal, obtaining the information on the country corresponding to the running application from the at least one of the one or more servers.

(Configuration 13) In any of Configurations 9 to 12, the method further includes, at the distribution terminal, transmitting application identification information for identification of the running application to the at least one of the one or more servers, at the at least one of the one or more servers, transmitting the application identification information together with the display policy information to the each of the plurality of reception terminals, at the each of the plurality of reception terminals, transmitting the application identification information together with a result of determination based on the display policy information to the at least one of the one or more servers, and at the at least one of the one or more servers, stopping the filtering for the each of the reception terminals indicated by the result of determination as being permitted to show the image, of which application identification information matches with the application identification information received from the distribution terminal.

(Configuration 14) In any of Configurations 9 to 13, the method further includes, at the distribution terminal, transmitting, when the distribution terminal starts distribution of the image, an image to the at least one of the one or more servers.

(Configuration 15) In any of Configurations 9 to 14, the method further includes, at the distribution terminal, transmitting to the at least one of the one or more servers, when the distribution terminal starts distribution of a home menu image, home menu image information indicating that an image to be transmitted is the home menu image, and at the at least one of the one or more servers, skipping the filtering distribution of the home menu image based on the home menu image information.

(Configuration 16) In Configuration 14, the method further includes, at the at least one of the one or more servers, when the distribution terminal changes from distribution of the image of the running application to distribution of a home menu image and thereafter changes to distribution of the image of the application identical to the image before distribution of the home menu image, filtering distribution of the image of the application for the each of the plurality of reception terminals based on filtering information indicating for which reception terminal the image of the application distributed by the distribution terminal before distribution of the home menu image has been filtered.

(Configuration 17) An exemplary embodiment provides a non-transitory computer-readable storage medium. The non-transitory computer-readable storage medium has instructions stored thereon which, when executed, cause one or more servers to perform operations including transmitting display policy information of an application being executed by a distribution terminal to each of a plurality of reception terminals while filtering distribution of an image of the application and stopping the filtering for the each of the plurality of reception terminals indicated by a result of determination by the each of the plurality of reception terminals as being permitted to show the image, among the plurality of reception terminals.

(Configuration 18) In Configuration 17, the display policy information includes information on age restriction. The instructions cause the one or more servers to further perform receiving from the distribution terminal, the information on the age restriction included in the application.

(Configuration 19) In Configuration 17 or 18, the display policy information includes information on a country. The instructions cause the one or more servers to further perform obtaining the information on the country corresponding to a running application.

(Configuration 20) In any of Configurations 17 to 19, the instructions cause the one or more servers to further perform receiving from the distribution terminal, application identification information for identification of the application being executed by the distribution terminal, transmitting to the each of the plurality of reception terminals, the application identification information together with the display policy information, receiving from the reception terminal, the application identification information together with a result of determination based on the display policy information, and stopping the filtering for the each of the reception terminals indicated by the result of determination as being permitted to show the image, of which application identification information matches with the application identification information received from the distribution terminal.

The foregoing and other objects, features, aspects, and advantages of the present disclosure will become more apparent from the following detailed description of the present disclosure when taken in conjunction with the accompanying drawings.

### BRIEF DESCRIPTION OF THE DRAWINGS

FIG. 1 shows an exemplary illustrative non-limiting drawing of an exemplary information processing system according to the present embodiment.

FIG. 2 shows an exemplary illustrative non-limiting drawing of an exemplary hardware configuration of a management server included in the information processing system according to the present embodiment.

FIG. 3 shows an exemplary illustrative non-limiting drawing of an exemplary hardware configuration of an image distribution server included in the information processing system according to the present embodiment.

FIG. 4 shows an exemplary illustrative non-limiting drawing of an exemplary hardware configuration of a game terminal included in the information processing system according to the present embodiment.

FIG. 5 shows an exemplary illustrative non-limiting drawing of an exemplary timing chart for illustrating distribution processing.

FIG. 6 shows an exemplary illustrative non-limiting drawing of an exemplary timing chart for illustrating processing in transition to a menu image.

### DETAILED DESCRIPTION OF NON-LIMITING EXAMPLE EMBODIMENTS

The present embodiment will be described in detail with reference to the drawings. The same or corresponding elements in the drawings have the same reference characters allotted and description thereof will not be repeated.

### EMBODIMENT

### [A. Overview]

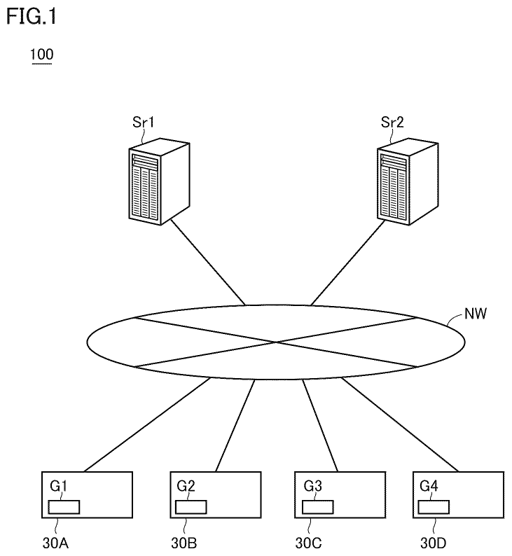

An exemplary configuration of an information processing system 100 according to the present embodiment will be described. FIG. 1 is a schematic diagram showing exemplary information processing system 100 according to the present embodiment. Information processing system 100 is a distribution system that provides a service to distribute an image of an application to game terminals 30A to 30D with a management server Sr1 and an image distribution server Sr2.

In the example in FIG. 1, information processing system 100 includes game terminals 30A to 30D, management server Sr1, and image distribution server Sr2. Game terminals 30A to 30D, management server Sr1, and image distribution server Sr2 are configured to be connectable to one another over a network NW. Network NW is typically the Internet.

Each of game terminals 30A to 30D is an information processing apparatus dedicated for a game for providing a game to a user by way of example. In the example in the present embodiment, game terminals 30A, 30B, 30C, and 30D hold game applications G1, G2, G3, and G4, respectively. Each game application may be held by being downloaded to each game terminal or may be held in each game terminal through a recording medium where it is recorded. Game terminals 30A to 30D are collectively referred to as a “game terminal 30” below. Game applications G1 to G4 are collectively simply referred to as a “game application G.” Game terminal 30 should only be a general-purpose information processing apparatus configured to execute at least a game. In one aspect, game terminal 30 may be an information processing apparatus such as a smartphone, a tablet, or a general-purpose PC.

In information processing system 100, various services are provided to each of game terminals 30A to 30D by connection of each of game terminals 30A to 30D to network NW. For example, each of game terminals 30A to 30D can download a new game application from a not-shown app distribution server or can play a match-up game or the like by communicating with another game terminal 30.

In information processing system 100 in the present embodiment, certain game terminal 30 can distribute an image of a running game application to another game terminal 30. More specifically, for example, game terminal 30A can distribute in real time, an image of running game application G1 to game terminals 30B to 30D. Users who operate respective game terminals 30B to 30D can thus view on their game terminals 30B to 30D, a user of game terminal 30A playing game application G1.

Management server Sr1 and image distribution server Sr2 are servers configured to provide a distribution service to distribute an image of a game application to game terminals 30A to 30D. Management server Sr1 is a server configured to manage game terminal 30 which is a source of distribution and a plurality of game terminals 30 which are destinations of distribution. Game terminal 30 which is a source of distribution is referred to as a “distribution terminal” below.

Game terminal 30 which is a destination of distribution is referred to as a “reception terminal” below. In other words, the reception terminal is game terminal 30 configured to receive an image of game application G executed by the distribution terminal and to show the received image to a user who operates the reception terminal. Furthermore, in information processing system 100 in the present embodiment, the user can receive distribution by another user while the user himself/herself distributes an image.

In other words, game terminal 30 can distribute, as the distribution terminal, an image of game application G being executed by the game terminal itself to another game terminal 30, and at the same time, can receive, as the reception terminal, an image from another game terminal 30. By way of example, game terminals 30A to 30D can all be distribution terminals and reception terminals. In this case, for example, game terminal 30A can receive images of game applications G distributed by game terminals 30B to 30D. Game terminal 30A may be able to simultaneously show all game applications G distributed by game terminals 30B to 30D or to show game applications as being switched one by one. In addition, game terminal 30A may be able to show on the game terminal itself, also an image distributed by the game terminal itself within network NW, simultaneously or as being switched.

Image distribution server Sr2 receives the image of running game application G from the distribution terminal and transmits the image to each of the plurality of reception terminals. Image distribution server Sr2 identifies as the reception terminal, game terminal 30 which is in a virtual room the same as the virtual room where distribution terminal 30 is in. For example, in an example where all of game terminals 30A to 30D are in the same virtual room and game terminal 30A distributes an image, image distribution server Sr2 identifies game terminals 30B, 30C, and 30D as the reception terminals. The virtual room may be generated by the user who operates game terminal 30A or by the users of game terminals 30B, 30C, and 30D.

The distributed image of game application G may be or may not be the same as the image shown on a display of game terminal 30 which is the source of distribution while game application G is running. For example, the distributed image of game application G may be processed such that an image is superimposed thereon, as compared with the image shown in game terminal 30 which is the source of distribution, or a bit rate, a frame rate, or a resolution thereof may be modified. Such a case can also substantially be concluded as distribution of moving images of game application G running in game terminal 30 which is the source of distribution. The distributed image of game application G is not limited to moving images but may be still images.

FIG. 1 illustrates four game terminals 30A to 30D which may function as at least one of the distribution terminal and the reception terminal. In other words, an example is shown in which four game terminals 30A to 30D are in the virtual room and three game terminals 30 function as the reception terminals for distribution from a single game terminal 30 which functions as the distribution terminal. The upper limit number of game terminals 30 that can be in a single virtual room may be set to several tens, several hundreds, or more.

In information processing system 100, age policy information may be set for game applications G1 to G4 running in respective game terminals 30A to 30D. The age policy information is information indicating a user in which age bracket is permitted to execute game application G.

The age policy information may include, for example, information indicating an age at or over which a user is permitted to execute game application G. For example, the age policy information may be a condition that a user 18 years of age or older is permitted to execute game application G.

In addition, country policy information may be set for game applications G1 to G4. The country policy information is information indicating in which country display of distribution contents of game application G is permitted. The country policy information may be set based on intention of a developer or a seller of game application G. The country policy information may include information indicating a country where display of distribution contents of game application G is allowed. The information indicating the country includes, for example, at least one of a list of countries where display of distribution contents is allowed and a list of countries where display of distribution contents is not allowed.

Information indicating whether or not execution of game application G or display of distribution contents of game application G is permitted, such as the age policy information and the country policy information, is thus associated with game application G. Information to be used for determination as to whether or not execution of game application G is permitted is referred to as execution policy information below. In other words, the execution policy information is information indicating a condition that sets whether or not a user is permitted to execute game application G. Information to be used for determination as to whether or not display of distribution contents of game application G is permitted is referred to as display policy information. Though description will be given later, in the present embodiment, the age policy information is also used as both of the execution policy information and the display policy information. The country policy information, on the other hand, is not used as the execution policy information but used only as the display policy information.

In the present embodiment, the age policy information indicating a condition that a user of 15 years of age or older is permitted to execute game application G1 is associated with game application G1. Similarly, the age policy information indicating a condition that a user of 12 years of age or older is permitted to execute game applications G2 and G4 is associated with game applications G2 and G4 and the age policy information indicating a condition that a user of 18 years of age or older is permitted to execute game application G3 is associated with game application G3.

In the present embodiment, the country policy information indicating a condition that display of distribution contents is permitted in an A country or a B country is associated with game application G1. The country policy information indicating a condition that display of distribution contents is permitted all over the world without designation of a country is associated with game applications G2 and G3. The country policy information indicating that display of distribution contents is permitted in the B country or a D country is associated with game application G4.

In the present embodiment, the age policy information is held in each game application G. The country policy information is stored, for example, in management server Sr1 or image distribution server Sr2, a not-shown app distribution server configured to distribute game application G, or another server for each game application G. Management server Sr1, image distribution server Sr2, a not-shown app distribution server, and the like may collectively be referred to as an “external server” below. The external server may store identification information for identification of game application G and the country policy information associated with the identification information. The identification information of game application G may simply be referred to as “app identification information” below.

### [B. Exemplary Hardware Configuration]

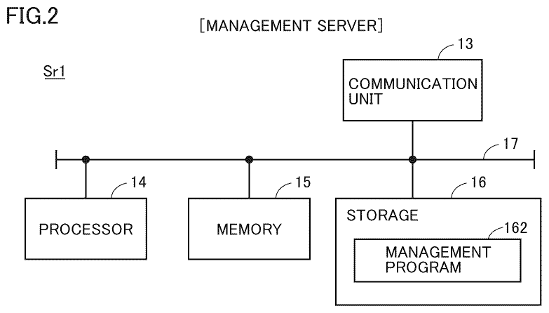

An exemplary hardware configuration of management server Sr1, image distribution server Sr2, and game terminal 30 included in information processing system 100 according to the present embodiment will be described below with reference to FIGS. 2 to 4.

FIG. 2 is a schematic diagram showing an exemplary hardware configuration of management server Sr1 included in information processing system 100 according to the present embodiment. Referring to FIG. 2, management server Sr1 includes one or more processors 14, a memory 15, a storage 16, and a communication unit 13. These components are connected to communicate data with one another through a bus 17. Management server Sr1 may be a dedicated information processing apparatus configured to manage the distribution terminal and the reception terminal or may be implemented by a general-purpose server.

Communication unit 13 communicates with game terminal 30 and image distribution server Sr2 over network NW. Communication unit 13 is provided with at least one of hardware necessary for wired communication and hardware necessary for wireless communication. The entirety or a part of processing by communication unit 13 may be performed by processor 14.

Processor 14 is a processing entity for performing processing provided by management server Sr1. The term “processor” in the present disclosure means processing circuitry such as a central processing unit (CPU), a micro processing unit (MPU), or a graphics processing unit (GPU). The term “processor” encompasses processing circuitry that performs processing in accordance with instruction codes described in a program, processing circuitry in which a plurality of functions are integrated, such as a system on chip (SoC), hard-wired circuitry, and the like.

Memory 15 is a volatile storage device (storage medium) accessible by processor 14, and for example, a dynamic random access memory (DRAM), a static random access memory (SRAM), or the like may be employed as memory 15. Storage 16 is a non-volatile storage device (storage medium) accessible by processor 14, and for example, a hard disk, a flash memory, or the like may be employed as storage 16. Storage 16 may be, for example, a storage medium attachable to and removable from management server Sr1, such as an optical disc and a cartridge.

A management program 162 to be executed by processor 14 is stored in storage 16. Processor 14 reads management program 162 and develops and executes the same on memory 15. The term “memory” herein encompasses at least also a volatile memory and a non-volatile storage.

Management program 162 includes a computer-readable instruction for performing processing in management server Sr1 such as processing for determining match of identification information of application G1 which will be described later. In execution of management program 162 by processor 14, a function provided by a not-shown system program (for example, an OS or the like) may be used.

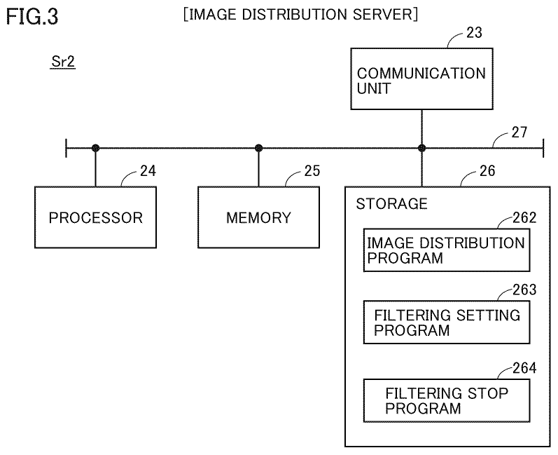

FIG. 3 is a schematic diagram showing an exemplary hardware configuration of image distribution server Sr2 included in information processing system 100 according to the present embodiment. Image distribution server Sr2 includes a communication unit 23, a processor 24, a memory 25, a storage 26, and a bus 27.

An image distribution program 262, a filtering setting program 263, and a filtering stop program 264 are stored in storage 26. Image distribution program 262 is a program for distribution of an image of game application G received from the distribution terminal to the reception terminal.

Filtering setting program 263 is a program for setting filtering for distribution of an image which will be described later. Filtering stop program 264 is a program for cancellation of filtering setting made by filtering setting program 263. In execution by processor 24, of various programs in storage 26 shown in FIG. 3, a function provided by a not-shown system program (for example, an OS or the like) may be used.

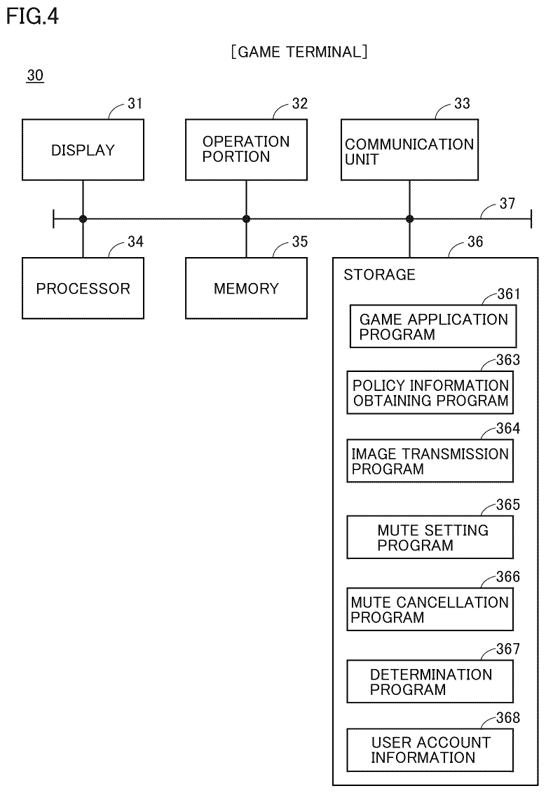

FIG. 4 is a schematic diagram showing an exemplary hardware configuration of game terminal 30 included in information processing system 100 according to the present embodiment. Game terminal 30 includes a display 31, an operation portion 32, a communication unit 33, a processor 34, a memory 35, a storage 36, and a bus 37.

Display 31 shows an image generated as a result of information processing performed by processor 34. In the present embodiment, display 31 shows an image of game application G to be distributed. In the present embodiment, display 31 may include a plurality of displays. Operation portion 32 accepts an operation by the user who operates game terminal 30. Operation portion 32 may include, for example, at least one of a push button, an operation lever, a touch panel, a mouse, and a keyboard.

Components included in game terminal 30 are connected to communicate data with one another through bus 37. Such a component as display 31 or operation portion 32 does not have to be included in game terminal 30. Game terminal 30 may output an image to an external display or may receive input from an external operation portion.

Game terminal 30 may communicate with at least one of a sound collection microphone, a speaker, and a camera which are not shown. They may or may not be included in game terminal 30. Thus, in information processing system 100, users who participate in distribution by the distribution terminal can perform a voice chat or video chat with the use of the sound collection microphone and the speaker. In information processing system 100, the users can naturally perform a text chat.

A game application program 361, a policy information obtaining program 363, an image transmission program 364, a mute setting program 365, a mute cancellation program 366, a determination program 367, and user account information 368 are stored in storage 36.

Game application program 361 is a program for execution of game application G and includes a program different in contents for each game application G.

Policy information obtaining program 363 is a program for obtaining the display policy information associated with game application G. Policy information obtaining program 363 may be a program the same as a program for obtaining the execution policy information associated with game application G.

Image transmission program 364 is a program for transmission of an image to be distributed to image distribution server Sr2. Mute setting program 365 is a program for control of a state of game terminal 30 to a mute state. The mute state refers to a state in which a mute image is transmitted as an image to be transmitted to image distribution server Sr2 by image transmission program 364.

The mute image may be an image which does not relate to game application G and a monochrome (for example, black) image or an image including such characters as “loading” by way of example. By executing mute setting program 365, game terminal 30 that functions as the distribution terminal temporarily suspends transmission of the image of game application G to image distribution server Sr2 when it starts distribution of the image of game application G.

Mute cancellation program 366 is a program for cancellation of the mute state set by mute setting program 365. As the mute state is canceled, the state of game terminal 30 makes transition to a state in which the image of running game application G is transmitted. In other words, game terminal 30 transmits the image of running game application G, as the image to be transmitted to image distribution server Sr2 by image transmission program 364.

Determination program 367 is a program for determining whether or not display of received distribution contents of game application G is permitted, by referring to the display policy information. In execution by processor 34, of various programs in storage 36 shown in FIG. 4, a function provided by a not-shown system program (for example, an OS or the like) may be used.

User account information 368 is information on an account associated for each game terminal 30. For example, user account information 368 may include a nickname of the user who operates game terminal 30A or age information of the user. User account information 368 may include information on accounts of one or more users. In other words, in information processing system 100 in the present embodiment, accounts of a plurality of users may be associated with single game terminal 30. Various programs included in each of storages 16, 26, and 36 described above include command codes for performing processing which will be described later.

### [C. Flow of Filtering Setting Processing]

An example will be described below in which, in information processing system 100 in the present embodiment, in order to determine whether or not a plurality of reception terminals which are destinations of distribution satisfy a condition indicated in the display policy information, the age policy information and the country policy information are transmitted from the distribution terminal via management server Sr1 to each reception terminal, each reception terminal itself determines whether or not it satisfies the display policy information, and image distribution server Sr2 is caused to set filtering based on a result of determination.

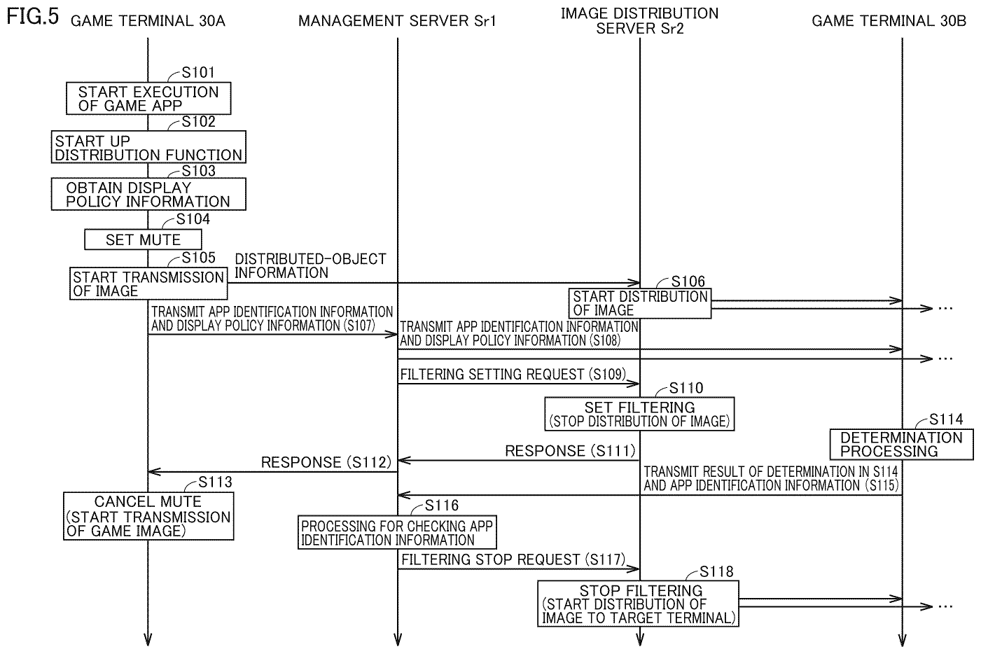

FIG. 5 is a timing chart for illustrating distribution processing. FIG. 5 shows operations by game terminals 30A and 30B, management server Sr1, and image distribution server Sr2 in a time-series manner. In an example shown in FIG. 5, an example in which game terminal 30A functions as the distribution terminal and distributes an image to other game terminals 30 including game terminal 30B will be described. For example, the user of game terminal 30A can distribute in real time, an image of play of game application G1 to other game terminals 30 including game terminal 30B. Through game terminal 30B is illustrated as a representative of other game terminals 30, similar processing is performed also in game terminals 30 other than that. Other game terminals 30 may consist of game terminal 30B. In other words, distribution and reception may be performed between two terminals of game terminal 30A and game terminal 30B.

Game terminal 30A executes game application program 361 and starts execution of game application G1 (step S101). In the present embodiment, game terminal 30A uses the age policy information also as the execution policy information. In this case, game terminal 30A obtains the age policy information in step S101. Whether or not execution of game application G1 is permitted is determined based on a youngest account among a plurality of accounts associated with game terminal 30A.

Specifically, game terminal 30A obtains age information of the youngest account among user accounts associated with game terminal 30A, by referring to user account information 368 stored in storage 36 thereof. In the example in FIG. 5, game terminal 30A obtains, for example, the age information indicating that the age of the youngest account associated with game terminal 30A is 18 years of age.

Since 18 years of age which is the age of the youngest account satisfies the condition of 15 years of age or older indicated as the age policy information of game application G1, game terminal 30A determines that it is permitted to execute game application G1. Accordingly, execution of game application G1 proceeds and an image of game application G1 is shown on display 31 of game terminal 30A. Game terminal 30A has the game proceed based on an operation from the user inputted to operation portion 32, and controls the image of game application G1 shown on display 31 as the game proceeds.

Game terminal 30A starts up a distribution function (step S102). For example, game terminal 30A starts up the distribution function based on acceptance from the user, of an instruction to start distribution of the image of running game application G1.

With start-up of the distribution function of game application G1, game terminal 30A executes policy information obtaining program 363 to obtain the display policy information of game application G1 (step S103). Game terminal 30A obtains as the display policy information, the age policy information stored in game application program 361 of game application G1. As described above, the age policy information indicating the condition that execution by the user of 15 years of age or older is permitted is associated with game application G1. In step S103, game terminal 30A transmits the identification information of game application G1 to the external server and obtains the country policy information indicating the country where execution of game application G1 is allowed as the display policy information. FIG. 5 shows the age policy information and the country policy information collectively as the “display policy information.”

In succession, game terminal 30A initially executes mute setting program 365 to set mute (step S104). In other words, when game terminal 30A controls the state of game terminal 30A to the mute state and transmits an image, it transmits the mute image instead of the image of game application.

In succession, game terminal 30A executes image transmission program 364 to start transmission of the image to image distribution server Sr2 (step S105). Since game terminal 30A is in the mute state, it transmits the mute image to image distribution server Sr2. At this time, game terminal 30A transmits to image distribution server Sr2, distributed-object information indicating an object to be distributed together with the mute image. The distributed-object information is information indicating contents to be distributed by the distribution terminal, and it is, for example, information indicating that distribution contents are the image of game application G or that distribution contents are a home menu image. Since the distribution function has been started up in step S102 for distribution of game application G1, the distributed-object information in step S105 is information indicating that the distribution contents are the image of game application G.

Image distribution server Sr2 executes image distribution program 262 to start distribution of the image received from the distribution terminal (step S106). Image distribution server Sr2 transmits the image received from the distribution terminal to each of the plurality of reception terminals including game terminal 30B. In step S106, image distribution server Sr2 distributes the mute image received from game terminal 30A to the plurality of reception terminals including game terminal 30B.

In step S105 or later, game terminal 30A keeps transmitting the image (the mute image at a time point of step S105) to image distribution server Sr2. Similarly, in step S106 or later, image distribution server Sr2 keeps transmitting the image received from game terminal 30A (the mute image at a time point of step S106) to each of the plurality of reception terminals.

In succession, game terminal 30A transmits to management server Sr1, the identification information of game application G1 as well as the age policy information and the country policy information obtained in step S103 (step S107). Management server Sr1 transmits the identification information of game application G1 and the age policy information and the country policy information received from game terminal 30A to each of the plurality of reception terminals including game terminal 30B (step S108).

Management server Sr1 requests image distribution server Sr2 to set filtering for distribution of the image received from game terminal 30A (step S109). An order to perform step S108 and step S109 may be reverse to the order shown in FIG. 5, or these steps may simultaneously be performed in parallel. The “filtering” in the present disclosure means restriction of distribution of an image to a reception terminal. Upon receiving a filtering setting request from management server Sr1, image distribution server Sr2 executes filtering setting program 263 to set filtering for distribution of the image received from game terminal 30A. Image distribution server Sr2 can set the filtering for each of the plurality of reception terminals. In step S110, image distribution server Sr2 sets the filtering for all of the plurality of reception terminals.

When the filtering is set, image distribution server Sr2 does not transmit the image received from game terminal 30A to the reception terminal for which the filtering has been set. For example, even when image distribution server Sr2 receives the image from game terminal 30A, it does not transmit the image to the reception terminal for which the filtering has been set.

Alternatively, image distribution server Sr2 may transmit the mute image generated by image distribution server Sr2 to the reception terminal for which the filtering has been set, regardless of contents of the image received from game terminal 30A. In this case, image distribution server Sr2 may overwrite the mute image received from game terminal 30A with a mute image newly generated by image distribution server Sr2, and may transmit the mute image to each of the plurality of reception terminals including game terminal 30B.

After processing in step S110, image distribution server Sr2 transmits to management server Sr1, a response signal indicating completion of filtering setting for all of the plurality of reception terminals (step S111). Furthermore, management server Sr1 transmits a response signal indicating reception of the response signal from image distribution server Sr2 to game terminal 30A (step S112). Game terminal 30A cancels mute by executing mute cancellation program 366 based on reception of the response signal (step S113). Thus, in step S113 or later, game terminal 30A keeps transmitting the image of game application G1 instead of the mute image to image distribution server Sr2.

Game terminal 30B performs determination processing for determining whether or not it is permitted to show game application G corresponding to the age policy information and the country policy information obtained in step S108, by referring to the age policy information and the country policy information (step S114). In other words, in step S114, the age policy information and the country policy information received in step S108 are used as the display policy information.

Game terminal 30B performs the determination processing in step S114 by executing determination program 367. Game terminal 30B determines whether or not the youngest account among a plurality of accounts associated with game terminal 30B satisfies the condition indicated in the age policy information and the country policy information obtained in step S108. In other words, regardless of the account by which game terminal 30B is operated, game terminal 30B determines whether or not it is permitted to show the image from game terminal 30A based on the age information youngest of the age information associated with the account and the age policy information obtained from management server Sr1.

In the example in FIG. 5, game terminal 30B obtains, for example, the age information indicating that the age of the youngest account associated with game terminal 30B is 15 years of age, by referring to user account information 368. In step S114, game terminal 30B determines that it is permitted to show the image from game terminal 30A via image distribution server Sr2, because 15 years of age which is the age of the youngest account satisfies the condition of 15 years of age or older indicated as the policy information received in step S108.

In addition, game terminal 30B obtains in which country it is used, and determines whether or not it is permitted to show the image received from game terminal 30A based on the country policy information obtained from management server Sr1. In the example in FIG. 5, game terminal 30B obtains information that it is used in the B country. In step S114, game terminal 30B determines that it is permitted to show the image of game application G1, because the country where it is used satisfies the condition in the country policy information that execution of game application G1 is permitted in the A country or the B country. Since game terminal 30B satisfies all the conditions indicated in the display policy information, it determines that it is permitted to show the image of game application G1.

Game terminal 30B transmits a result of determination in step S114 and the identification information of game application G1 received in step S108 to management server Sr1 (step S115). Management server Sr1 executes management program 162 to perform processing for checking app identification information (step S116).

Specifically, management server Sr1 determines whether or not the identification information of game application G received from game terminal 30A in step S107 matches with the identification information of game application G received from game terminal 30B in step S115. In the example in FIG. 5, since the identification information of game application G received in step S107 and the identification information of game application G received in step S115 are both the identification information of game application G1, they match with each other.

Since the identification information of game application G received in step S115 matches with the identification information of game application G received in step S107, management server Sr1 requests image distribution server Sr2 to stop the filtering set for the reception terminal that has transmitted the identification information of game application G (S117). Upon receiving the filtering stop request from management server Sr1, image distribution server Sr2 executes filtering stop program 264 to stop the filtering set for game terminal 30B (step S118). Match of the identification information is thus checked. Therefore, for example, when the game application executed by game terminal 30A is changed to a game application including different policy information while game terminal 30B is performing the determination processing, distribution of an image of the game application to game terminal 30B can be suppressed. For example, when a condition indicated as the display policy information is not satisfied as a result of determination processing in another game terminal 30C, management server Sr1 that receives the result instructs image distribution server Sr2 to maintain the filtering set for game terminal 30C. The image of game application G executed by game terminal 30A is thus not distributed to game terminal 30C.

As the filtering for game terminal 30B is stopped, image distribution server Sr2 cancels restriction of distribution of the image to game terminal 30B. In other words, image distribution server Sr2 transmits the image received from game terminal 30A to game terminal 30B.

In the example in FIG. 5, the mute state of game terminal 30A is canceled before step S118. Therefore, at a time point of step S118, image distribution server Sr2 has received the image of game application G1 from game terminal 30A. As a result of stop of the filtering in step S118, image distribution server Sr2 transmits the image of game application G1 received from game terminal 30A to game terminal 30B in step S118 or later.

Thus, in information processing system 100 in the present embodiment, the age policy information and the country policy information themselves are transmitted from game terminal 30A via management server Sr1 to all reception terminals. The all reception terminals use the age policy information and the country policy information as the display policy information to determine whether or not they are game terminals 30 allowed to show the image. Thus, in information processing system 100 in the present embodiment, a scheme for determining whether or not a plurality of reception terminals which are destinations of distribution satisfy a condition indicated in the display policy information determined in advance for game application G can be realized.

Management server Sr1 or image distribution server Sr2 may determine whether or not each reception terminal satisfies the display policy information. In this case, determination program 367 for determination as to whether or not the display policy information is satisfied should be incorporated in management server Sr1 or image distribution server Sr2.

Furthermore, in information processing system 100 in the present embodiment, in addition to filtering setting by image distribution server Sr2, the state of game terminal 30 that functions as the distribution terminal temporarily makes transition to the mute state at the time of start of distribution. Thus, even when start of processing for setting filtering in image distribution server Sr2 is delayed by unintended processing, delay in communication, or the like, in information processing system 100 in the present embodiment, transmission of the image of game application G to game terminal 30 that does not satisfy the condition indicated in the policy information can more reliably be suppressed.

A series of processing shown in FIG. 5 is performed also when other game terminals 30B to 30D function as the distribution terminals. For example, when all of game terminals 30A to 30D function as the distribution terminals and the reception terminals, game terminal 30A as the distribution terminal obtains the display policy information as shown in FIG. 5 and transmits the display policy information to each reception terminal, obtains from each of game terminals 30B to 30D which are also the distribution terminals, the app identification information and the display policy information relating to game application G to be distributed by each game terminal 30, and performs the determination processing for each of them. Consequently, images from which distribution terminals 30A to 30D are shown may be different among reception terminals 30A to 30D.

The series of processing shown in FIG. 5 is performed each time of change of game application G executed by game terminal 30A. In other words, when game terminal 30A executes another game application G while it distributes the image, it again sets mute (S104) and performs again subsequent processing.

Game terminal 30 may be in the mute state not only for a temporary period after start-up of the distribution function but also for a period for which a screen is shown. By way of example, the game terminal may be in the mute state while a screen for setting a function of a terminal main body or a screen for purchase of a game application is shown.

Game terminal 30 thus determines whether or not it is permitted to show distribution contents from points of view of both of the age policy information and the country policy information. Since both of the age policy information and the country policy information are used as the display policy information in the present embodiment, game terminal 30 determines that it is permitted to show distribution contents only when it determines that both of the age policy information and the country policy information are satisfied. In one aspect, at least one of the age policy information and the country policy information may be used as the display policy information. Alternatively, in another aspect, other policy information may be used.

### [D. Execution of Home Menu]

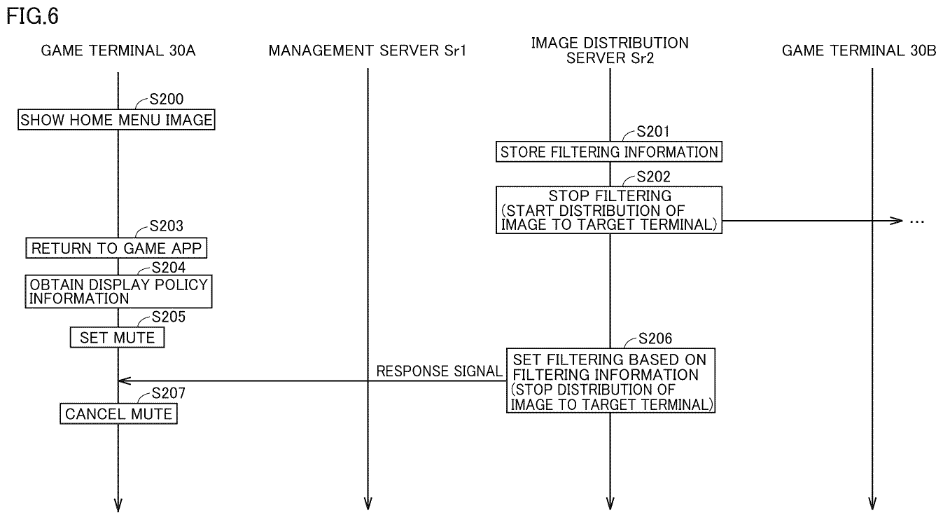

FIG. 6 is a timing chart for illustrating processing when a home menu is executed. Game terminal 30 can execute the home menu while it executes game application G. Game application G may keep running in the background, may temporarily be suspended, or may be closed. The home menu is, for example, a function to have a user select game application G to be executed, and it has a home menu screen shown on display 31. The home menu screen may include an item for setting a function of the game terminal, an item for connection to an on-line store for purchase of game application G, and an item for setting for each account. FIG. 6 illustrates a flow of processing in information processing system 100 when the home menu is executed.

When the home menu is executed while game application G is running, a home menu image instead of the image of game application G is shown on display 31 of game terminal 30.

In the present embodiment, the home menu image is distributed to another user. In the present embodiment, when the home menu is executed while the image of game application G is being distributed, game terminal 30 transmits the home menu image to image distribution server Sr2. When image distribution server Sr2 receives the home menu image from game terminal 30, it sets filtering for none of reception terminals. For example, when the filtering has previously been set for a certain reception terminal, the filtering is stopped. Thus, in information processing system 100 in the present embodiment, the home menu image can be distributed to all reception terminals.

The timing chart shown in FIG. 6 is started from a state of distribution of game application G1 by game terminal 30A, such as a state immediately after processing in step S118 in FIG. 5. Game terminal 30A accepts an instruction to execute the home menu from the user and shows the home menu image (step S200). Game terminal 30A does not set mute when it shows the home menu image. In other words, the image transmitted by performing step S200 is switched from the image of game application G so far to the home menu image.

At this time, game terminal 30A transmits the distributed-object information to image distribution server Sr2 together with the home menu image. The distributed-object information transmitted after step S200 includes information indicating that distribution contents are the home menu image.

When image distribution server Sr2 receives the distributed-object information including information that the distribution contents are the home menu image, it stores information on filtering currently set for each of the plurality of reception terminals (step S201). Thereafter, image distribution server Sr2 stops the filtering for all reception terminals (step S202). Therefore, as a result of stop of the filtering, game terminal 30 that has been unable to receive the image of game application G1 from game terminal 30A due to previous filtering receives the home menu image. Game terminal 30 that has already been receiving the image of game application G1 keeps receiving the home menu image.

Thus, after step S202, the home menu image shown on display 31 of game terminal 30A is distributed to game terminals 30B, 30C, and 30D. In succession, game terminal 30A accepts from the user, an instruction to return to execution of application G1 from the home menu image and returns to game application G1 (step S203). In other words, the image of game application G1 is again shown on display 31 of game terminal 30A.

Based on return to game application G1, game terminal 30A obtains the age policy information and the country policy information of game application G1 as the display policy information (step S204). In addition, game terminal 30A sets mute (step S205). Consequently, the image transmitted from game terminal 30A to image distribution server Sr2 is the mute image.

At this time, game terminal 30A transmits the distributed-object information indicating the object to be distributed to image distribution server Sr2, together with the mute image. At the time point in step S206, the game terminal has returned to game application G1, and hence the distributed-object information after step S203 is information indicating that the distribution contents are the image of game application G1.

Image distribution server Sr2 distributes the mute image to the plurality of reception terminals based on reception of the mute image from game terminal 30A. Image distribution server Sr2 receives information indicating that the distribution contents as the distributed-object information are the image of game application G1. Since this game application G1 is the same as game application G1 distributed before distribution of the home menu image, image distribution server Sr2 sets filtering based on the filtering information stored in step S201 (step S206). For example, for game terminal 30B, the filtering is not set and a state in which the filtering has been stopped is maintained.

In other words, image distribution server Sr2 sets filtering setting back to filtering setting the same as before display of the home menu image. Thereafter, image distribution server Sr2 transmits the response signal to game terminal 30A based on return of filtering setting to original setting. Game terminal 30A cancels mute based on reception of the response signal (step S207).

Thus, in information processing system 100 in the present embodiment, the home menu is executed while game application G1 is running, and when the game terminal returns to game application G1, filtering is set again based on the filtering information stored in image distribution server Sr2. The reception terminal thus does not have to perform the determination processing again, and for example, an amount of communication generated in information processing system 100 can be reduced or increase in processing load can be suppressed.

### [E. Modification]

Other forms which are partial modification of the embodiment described above will be described below.

Each of processors 14, 24, and 34 may be composed of a single chip or a plurality of chips. Each of processors 14, 24, and 34 and associated processing circuitry may be composed of a plurality of computers connected to one another through a wire or wirelessly over a local area network, a wireless network, or the like. The processor and the associated processing circuitry may be implemented by such a cloud computer as performing remote computation based on input data and outputting a result of computation to another device located at a distant location.

In the example in FIG. 1, information processing system 100 includes management server Sr1 and image distribution server Sr2. Management server Sr1 and image distribution server Sr2, however, may be provided as one integrated server. Though information processing system 100 includes a single image distribution server Sr2 in the example in FIG. 1, image distribution server Sr2 may be configured, for example, to include a plurality of image distribution servers Sr2 separately for each game application G to be distributed. In addition, functions of management server Sr1 and image distribution server Sr2 may further be performed by a plurality of servers.

In the example described above, an example where the age policy information is stored in game application program 361 is described. The age policy information, however, may be stored in an external server instead of game application program 361 for execution of game application G. In this case, the distribution terminal obtains the age policy information corresponding to the game application from the external server over network NW. The country policy information, on the other hand, may be stored in game application program 361.

In the example described above, the age policy information is used as the execution policy information and the display policy information. The age policy information as the display policy information and the age policy information as the execution policy information, however, may be different from each other. In the example described above, the country policy information is used as the display policy information. The country policy information, however, may be used as the execution policy information, or country policy information as the execution policy information may separately be prepared.

In the example described above, though an example where the home menu image is distributed to another user is described, it does not have to be distributed to another user.

FIGS. 5 and 6 show exchange of information of the same type between different elements. For example, game terminal 30A transmits the identification information of game application G1 as well as the age policy information and the country policy information to management server Sr1 in step S107. Thereafter, management server Sr1 transmits the identification information of game application G1 and the age policy information and the country policy information to game terminal 30B in step S108. The identification information of game application G1 and the age policy information and the country policy information transmitted from game terminal 30A and the identification information of game application G1 and the age policy information and the country policy information transmitted from management server Sr1 should only be data indicating the same contents, and they do not have to be exactly the same data. In other words, in the present disclosure, information of the same type exchanged between different elements is not required to be exactly the same data. This is also applicable to exchange of information of the same type in a single element.

In the example described above, the display policy information for determination as to whether or not display of game application G is permitted for each country is described. Whether or not display of game application G is permitted, however, may be set for a region smaller or larger than a country.

In the example described above, an example in which filtering is set for all reception terminals in the processing for setting filtering in step S110 in FIG. 5 is described. Filtering for all reception terminals, however, may be set, for example, before step S106 in which image distribution server Sr2 starts distribution of the image. In this case, in the processing for setting filtering in step S110, for example, processing for checking whether or skipping the filtering has been set for all reception terminals may be performed.

In the example described above, processing for determining whether or not execution of game application G is permitted with the youngest account among accounts associated with game terminal 30 being defined as the reference is described. Rather than the youngest account, the age of the currently used account in game terminal 30 may be defined as the reference.

In the example described above, an example in which game terminal 30A cancels mute by receiving the response signal from management server Sr1 or image distribution server Sr2 is described. Mute, however, may be canceled based on lapse of a predetermined period since setting of the mute.

In the example described above, transmission of the home menu image as the distributed-object information after step S200 in FIG. 6 is shown. Instead, information indicating that previously transmitted display policy information may be ignorable may be transmitted. This information may be transmitted to management server Sr1, and management server Sr1 may set filtering by image distribution server Sr2.

In the example described above, filtering information is stored in step S201 in FIG. 6. Specifically, filtering information at a certain time point is saved, and alternative filtering information such as information while filtering for all terminals has been stopped is applied. Instead, while filtering information at a certain time point itself is maintained, for example, switching to setting higher in priority, such as “ignoring the display policy information,” may be made to consequently cancel previous filtering setting.

Processing in FIG. 5 or 6 is merely by way of example. For example, mute does not have to be set. For example, the game terminal may not be permitted to start distribution until filtering setting is completed. For example, checking processing based on the identification information does not have to be performed. Whether or not to perform processing or the order of processing may be modified as appropriate and addition of other processing or replacement with other processing may be performed as appropriate.

In the example described above, an example in which, in execution of game application G, game terminal 30 itself executes game application G is described. In one aspect, however, game application G may be executed in an external server or other game terminal 30 and an output image may be shown on another game terminal.

In the example described above, though the age policy information and the country policy information are exemplified as the display policy information, other policy information may be included in addition thereto, at least one of them may be included, or neither of them may be included but other policy information may be included.

In the example described above, the game terminal as the distribution terminal distributes the image of game application G. The distribution terminal, however, may be an information processing apparatus other than the game terminal. For example, an image of a video image reproduction application or an education application other than the game application may be distributed. This is also applicable to the reception terminal.

In the example described above, in information processing system 100, determination program 367 for determining whether or not execution and display of game application G is permitted is described as being provided in game terminal 30. Determination program 367 may be a program for determining not only whether or not the condition in the display policy information is satisfied but also whether or not the condition in the execution policy information is satisfied. In this case, game terminal 30 can use determination program 367 also for determination of a condition in the execution policy information and the display policy information.

When “association” is referred to in the present disclosure, whether two elements are directly or indirectly associated with each other does not matter. For example, two elements may directly be associated with each other in the same table, or may indirectly be associated with each other with another element being interposed.

The “server” in the present disclosure encompasses both of meaning of a computing resource (hardware) for performing processing necessary as the server and meaning of a program for performing processing necessary as the server or a state (software) in which the program is being executed. The server includes also a virtual server by way of example.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A system comprising:
one or more servers;
a distribution terminal configured to distribute an image of a running application via the one or more servers; and
a plurality of reception terminals configured to receive the image distributed by the distribution terminal,
the distribution terminal comprising one or more memories storing instructions that, when executed, cause one or more computers of the distribution terminal to perform operations comprising
obtaining display policy information of the running application, and
transmitting the display policy information and the image to at least one of the one or more servers,
at least one of the one or more servers comprising one or more memories storing instructions that, when executed, cause one or more computers of the at least one of the one or more servers to perform operations comprising
transmitting the display policy information to each of the plurality of reception terminals while filtering distribution of the image,
each of the plurality of reception terminals comprising one or more memories storing instructions that, when executed, cause one or more computers of the each of the plurality of reception terminals to perform operations comprising
determining whether the each of the plurality of reception terminals itself is permitted to show the image based on the display policy information obtained from the at least one of the one or more servers, and
transmitting a result of determination to the at least one of the one or more servers,
the operations performed by the at least one of the one or more servers comprising
stopping the filtering for the each of the reception terminals indicated by the result of determination as being permitted to show the image, among the plurality of reception terminals.

2. The system according to claim 1, wherein
the display policy information comprises information on age restriction, and
the operations performed by the distribution terminal comprise obtaining from the application, the information on the age restriction included in the application.

3. The system according to claim 2, wherein
the operations performed by the each of the plurality of reception terminals comprise determining whether the each of the plurality of reception terminals is permitted to show the image based on age information youngest of age information associated with one or more accounts associated with the each of the reception terminals and the display policy information obtained from the at least one of the one or more servers.

4. The system according to claim 1, wherein
the display policy information comprises information on a country, and
the operations performed by the distribution terminal comprise obtaining the information on the country corresponding to the running application from the at least one of the one or more servers.

5. The system according to claim 1, wherein
the operations performed by the distribution terminal comprise transmitting application identification information for identification of the running application to the at least one of the one or more servers,
the operations performed by the at least one of the one or more servers comprise transmitting the application identification information together with the display policy information to the each of the plurality of reception terminals,
the operations performed by the each of the plurality of reception terminals comprise transmitting the application identification information together with the result of determination based on the display policy information to the at least one of the one or more servers, and
the operations performed by the at least one of the one or more servers comprise stopping the filtering for the each of the reception terminals indicated by the result of determination as being permitted to show the image, of which application identification information matches with the application identification information received from the distribution terminal.

6. The system according to claim 1, wherein
the operations performed by the distribution terminal comprise transmitting, when the distribution terminal starts distribution of the image, an image to the at least one of the one or more servers.

7. The system according to claim 1, wherein
the operations performed by the distribution terminal comprise transmitting, when the distribution terminal starts distribution of a home menu image, home menu image information indicating that an image to be transmitted is the home menu image to the at least one of the one or more servers, and
the operations performed by the at least one of the one or more servers comprise skipping the filtering distribution of the home menu image based on the home menu image information.

8. The system according to claim 6, wherein
the operations performed by the at least one of the one or more servers comprise filtering, when the distribution terminal changes from distribution of the image of the running application to distribution of a home menu image and thereafter changes to distribution of the image of the application identical to the image before distribution of the home menu image, distribution of the image of the application for the each of the plurality of reception terminals based on filtering information indicating for which reception terminal the image of the application distributed by the distribution terminal before distribution of the home menu image is filtered.

9. A method of distributing, by a distribution terminal, an image of a running application via one or more servers with an information processing system, the method comprising:
at the distribution terminal,
obtaining display policy information of the running application, and
transmitting the display policy information and the image to at least one of the one or more servers;
at the at least one of the one or more servers,
transmitting the display policy information to each of a plurality of reception terminals while filtering distribution of the image;
at the each of the plurality of reception terminals,
determining whether the each of the plurality of reception terminal itself is permitted to show the image based on the display policy information obtained from the at least one of the one or more servers, and
transmitting a result of determination to the at least one of the one or more servers; and
at the at least one of the one or more servers,
stopping the filtering for the each of the plurality of reception terminals indicated by the result of determination as being permitted to show the image, among the plurality of reception terminals.

10. The method according to claim 9, wherein
the display policy information comprises information on age restriction, and
the method further comprises, at the distribution terminal, obtaining from the application, the information on the age restriction included in the application.

11. The method according to claim 10, further comprising, at the each of the plurality of reception terminals, determining whether the each of the plurality of reception terminals is permitted to show the image based on age information youngest of age information associated with one or more accounts associated with the each of the reception terminals and the display policy information obtained from the at least one of the one or more servers.

12. The method according to claim 9, wherein
the display policy information comprises information on a country, and
the method further comprises, at the distribution terminal, obtaining the information on the country corresponding to the running application from the at least one of the one or more servers.

13. The method according to claim 9, further comprising:
at the distribution terminal, transmitting application identification information for identification of the running application to the at least one of the one or more servers;
at the at least one of the one or more servers, transmitting the application identification information together with the display policy information to the each of the plurality of reception terminals;
at the each of the plurality of reception terminals, transmitting the application identification information together with a result of determination based on the display policy information to the at least one of the one or more servers; and
at the at least one of the one or more servers, stopping the filtering for the each of the reception terminals indicated by the result of determination as being permitted to show the image, of which application identification information matches with the application identification information received from the distribution terminal.

14. The method according to claim 9, further comprising, at the distribution terminal, transmitting, when the distribution terminal starts distribution of the image, an image to the at least one of the one or more servers.

15. The method according to claim 9, further comprising:
at the distribution terminal, transmitting to the at least one of the one or more servers, when the distribution terminal starts distribution of a home menu image, home menu image information indicating that an image to be transmitted is the home menu image; and
at the at least one of the one or more servers, skipping the filtering distribution of the home menu image based on the home menu image information.

16. The method according to claim 14, further comprising, at the at least one of the one or more servers, when the distribution terminal changes from distribution of the image of the running application to distribution of a home menu image and thereafter changes to distribution of the image of the application identical to the image before distribution of the home menu image, filtering distribution of the image of the application for the each of the plurality of reception terminals based on filtering information indicating for which reception terminal the image of the application distributed by the distribution terminal before distribution of the home menu image has been filtered.

17. A non-transitory computer-readable storage medium having instructions stored thereon which, when executed, cause one or more servers to perform operations comprising:
transmitting display policy information of an application being executed by a distribution terminal to each of a plurality of reception terminals while filtering distribution of an image of the application; and
stopping the filtering for the each of the plurality of reception terminals indicated by a result of determination by the each of the plurality of reception terminals as being permitted to show the image, among the plurality of reception terminals.

18. The non-transitory computer-readable storage medium according to claim 17, wherein
the display policy information comprises information on age restriction, and
the instructions cause the one or more servers to further perform receiving from the distribution terminal, the information on the age restriction included in the application.

19. The non-transitory computer-readable storage medium according to claim 17, wherein
the display policy information comprises information on a country, and
the instructions cause the one or more servers to further perform obtaining the information on the country corresponding to a running application.

20. The non-transitory computer-readable storage medium according to claim 17, wherein
the instructions cause the one or more servers to further perform
receiving from the distribution terminal, application identification information for identification of the application being executed by the distribution terminal,
transmitting to the each of the plurality of reception terminals, the application identification information together with the display policy information,
receiving from the reception terminal, the application identification information together with a result of determination based on the display policy information, and
stopping the filtering for the each of the reception terminals indicated by the result of determination as being permitted to show the image, of which application identification information matches with the application identification information received from the distribution terminal.
